(19) United States
(12) Patent Application Publication
(10) Pub. No.: US 2006/0089904 A1
(43) Pub. Date: Apr. 27, 2006

(54) Price point

(76) Inventor: DeepGreen Financial-Jeff Bell, Seven Hills, OH (US)

Correspondence Address: DeepGreen Financial;c/o Jeff Bell, CIO, SUITE 100, 5800 LOMBARDO CENTER DRIVE, SEVEN HILLS, OH, 44131, US

(21) Appl. No.: 10/973,603

(22) Filed: Oct. 27, 2004

(51) Int. Cl. G06Q 40/00

(52) U.S. Cl. 705/38

(57) ABSTRACT

The Price Point Pricing Center is a flexible system designed to provide the business with industry-standard pricing methodologies, including: The ability to charge different rates based on an application's source Risk-based pricing, including the ability to price based on drivers such as credit source, CLTV, and line amount The ability to change penalties such as late payment fees, return item fees, and over limit fees The ability to change broker compensation based on the program the originator selects The ability for customers and originators to receive multiple offers for their application The ability to create a driver from any data source available.

### BACKGROUND & SUMMARY

DeepGreen Financial is an Internet Service Provider that specializes in underwriting and funding loan products. In order to accommodate a diverse market and maintain competitive advantage, DeepGreen Financial designed Price Point. This is a flexible system designed to provide DeepGreen Financial with (1) the ability to adjust rates based on any attribute associated with a loan, (2) ability to apply fee differentials, (3) tie Broker compensation to specific programs, (4) and to select multiple qualifying products based on predetermined drivers.

A loan application has many attributes associated with it. Price Point is flexible and allows DeepGreen Financial the ability to set up programs based on any of these attributes. For instance, it may be based on the source of the loan, which consists of the channel (general customer grouping such as retain, wholesale, etc.), delivery (technology used to provide application such as xml, web site, etc), and party (company providing the application).

There are also various fees charged by DeepGreen Financial. Price Point was set up to accommodate multiple fee structures per fee. However, only one fee structure per fee would apply to any one program. For example, non-sufficient fund fee would be $25 for program A and would be $30 for program B.

DeepGreen Financial has partnerships with many Brokerages. These brokerages have many loan originators that submit one to many loan applications to DeepGreen Financial. Price Point allows DGB to tie a specified broker fee to a program. This fee is then paid to the Brokerage each time a loan books.

Price Point is also built to present all programs that the customer qualifies for based upon the preset drivers for that program. For example, if a program or programs quality for a range of FICO scores, range of CLTV, and maximum loan amount, the customer may get multiple offers for multiple products. They may then select the appropriate product that satisfies their needs. The consumer may change their program selection at any time up to eight days prior to the closing event.

### BRIEF DESCRIPTION OF THE MODELS

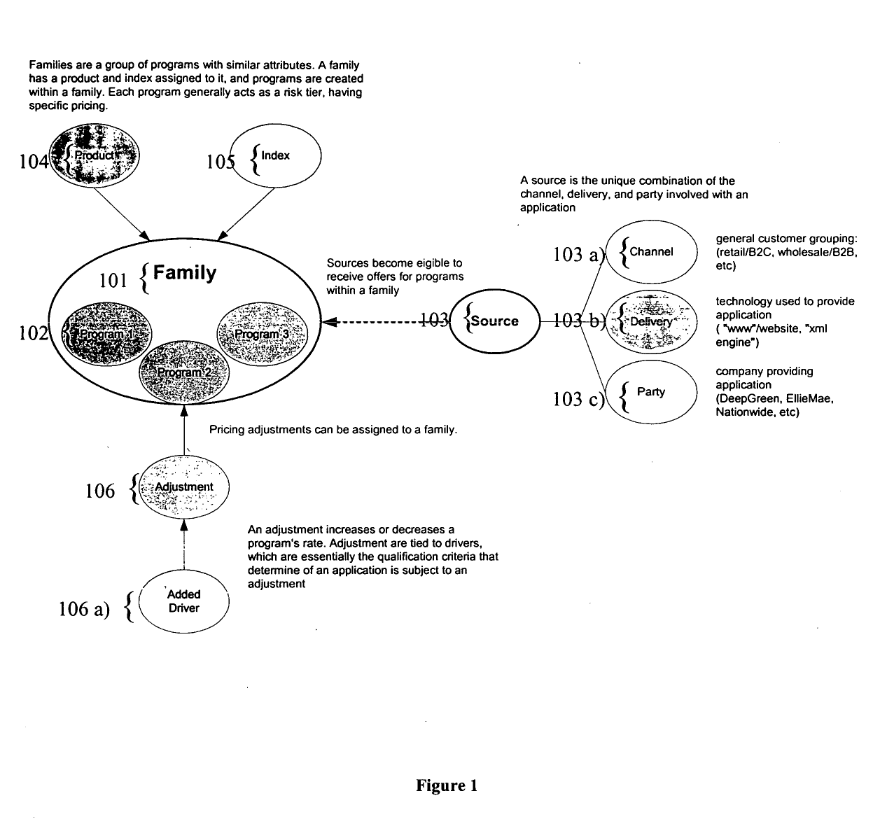

FIG. 1 illustrates the overview of the Pricing Model components.

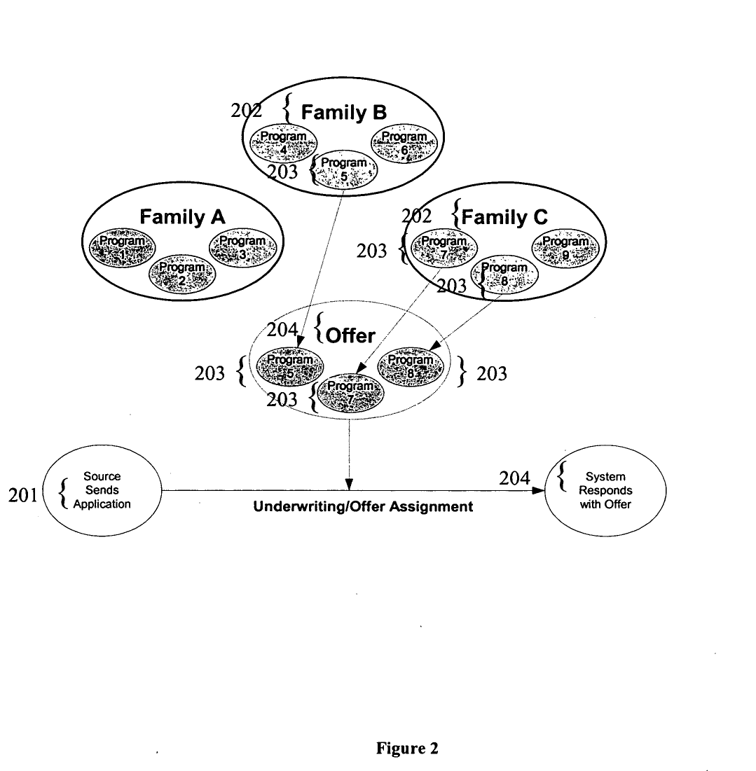

FIG. 2 illustrates the association between programs and families.

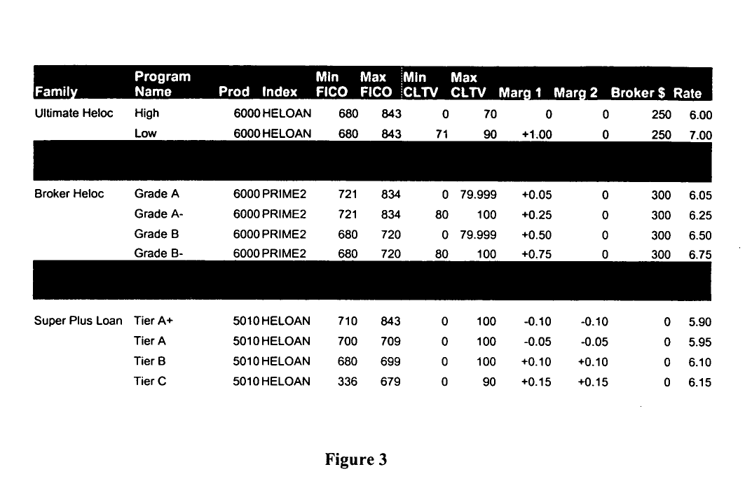

FIG. 3 illustrates how programs are displayed on the website.

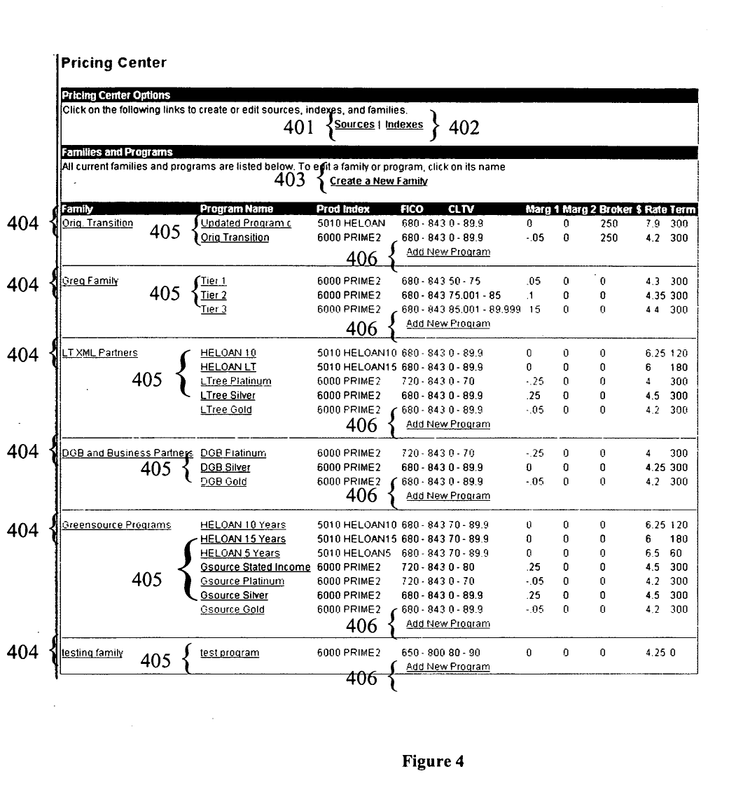

FIG. 4 illustrates the “Pricing Center”, which is the user interface for setting up Sources, Indexes, creation of new families, and addition of new families.

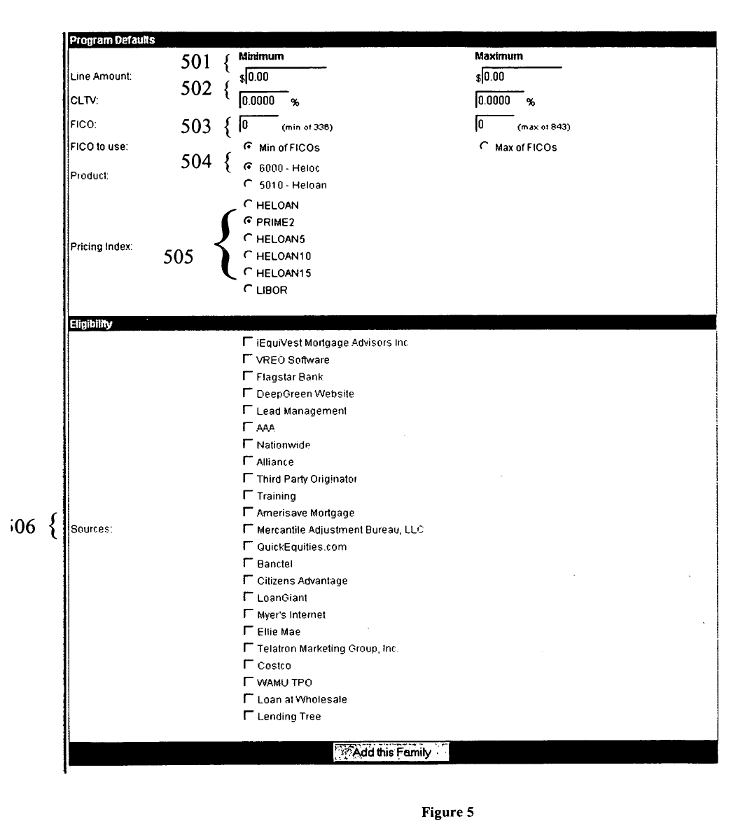

FIG. 5 is the user interface for creating a new family.

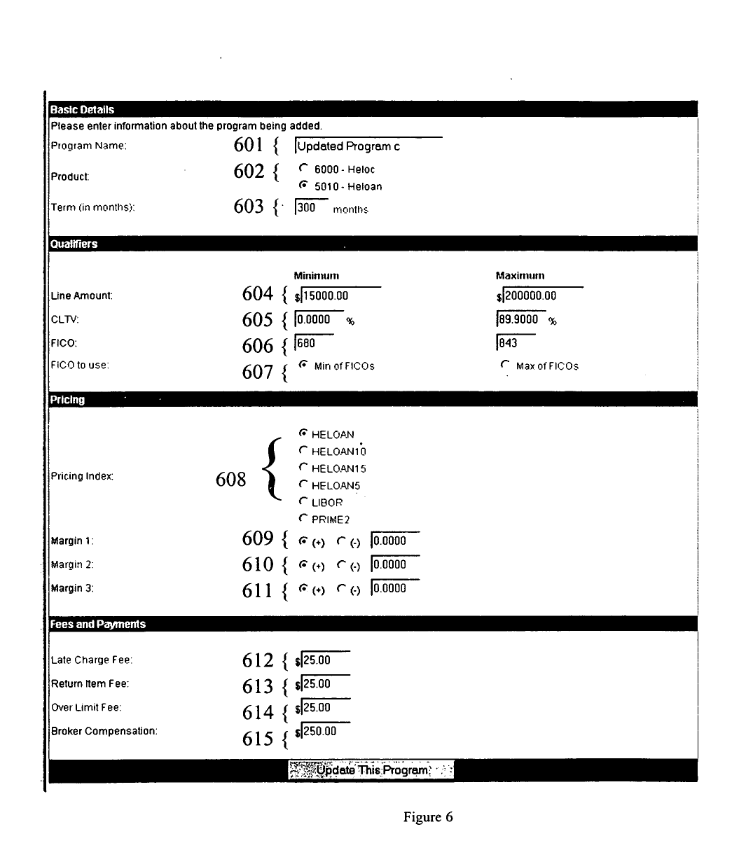

FIG. 6 is the user interface for creating a new program.

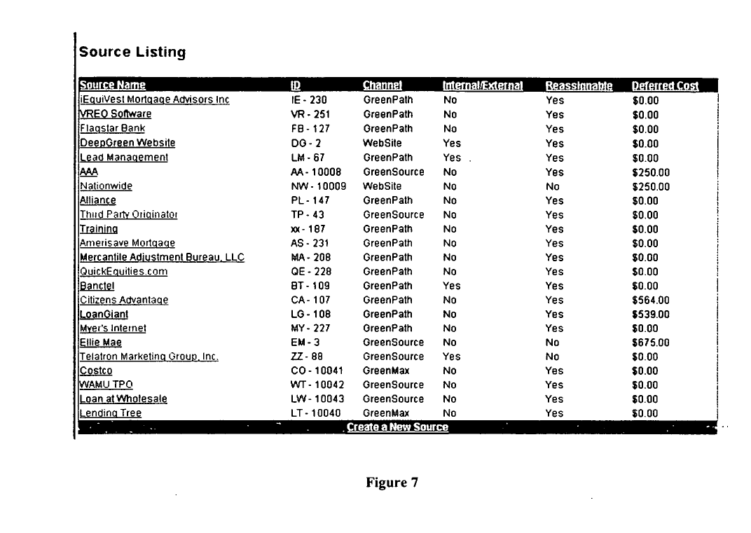

FIG. 7 is the Source Listing that identifies all sources for editing and/or allows you to create a new source.

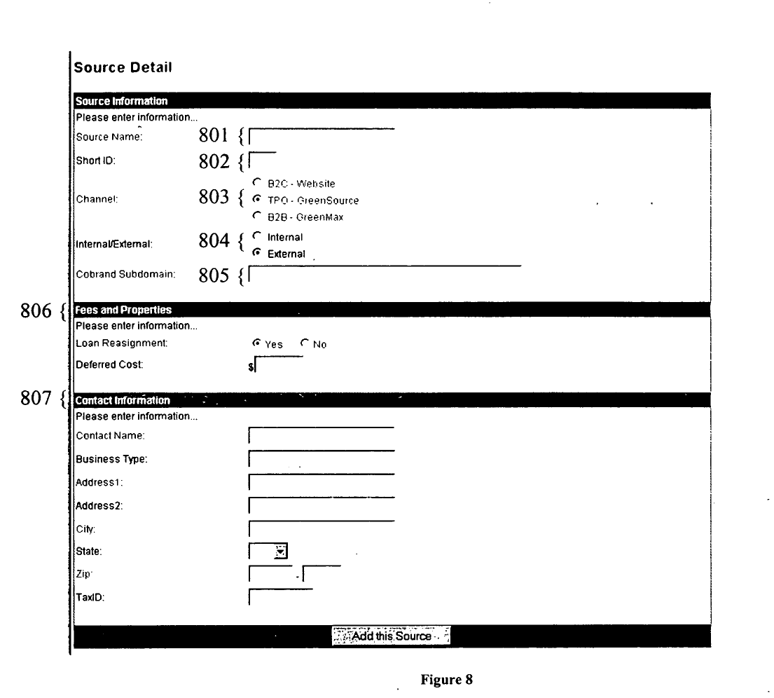

FIG. 8 is the Source Detail form that is used to set up a new Source, which includes Channel, Delivery, and Party.

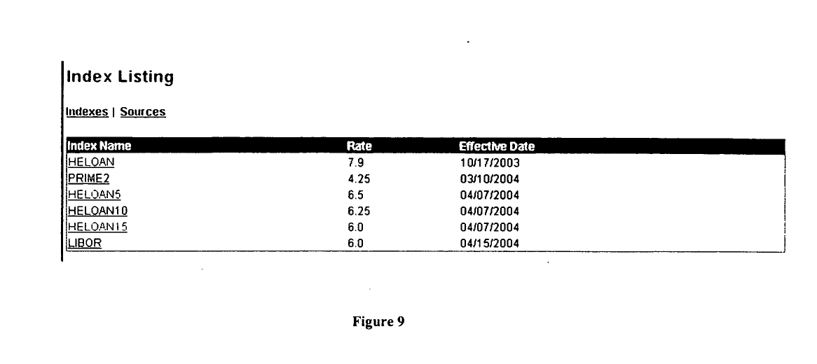

FIG. 9 is the Index listing user interface

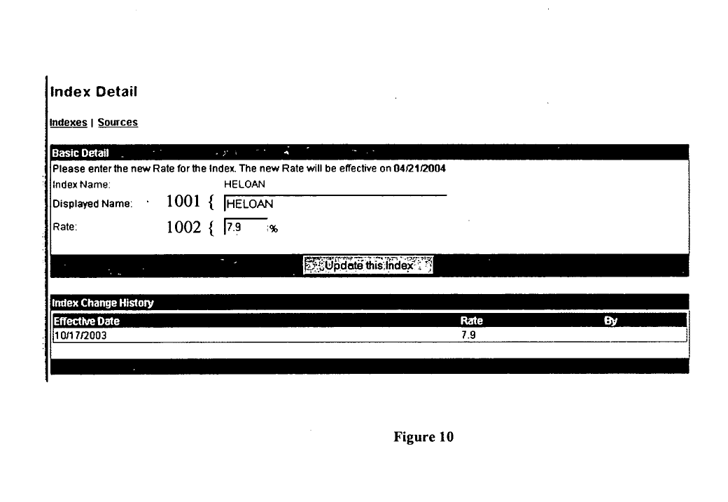

FIG. 10 is the Index Detail Form, which allows updates to the Index Name and Rate.

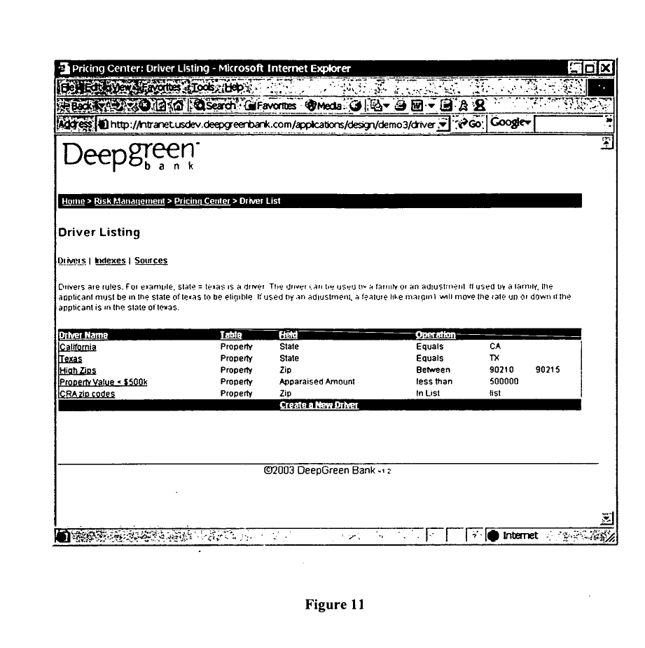

FIG. 11 is the Driver Listing user interface

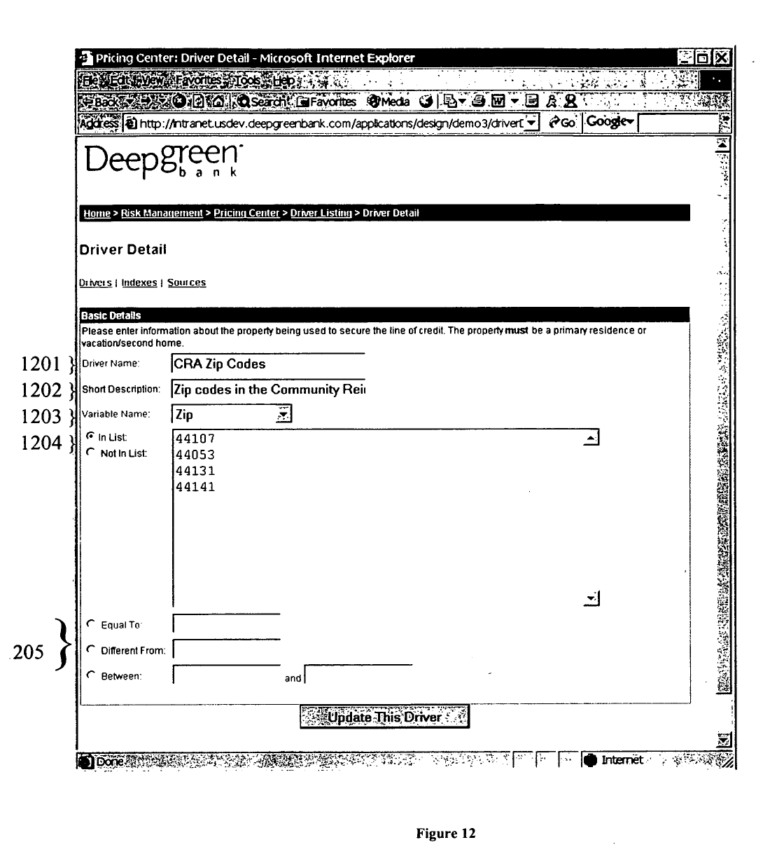

FIG. 12 is the Driver Detail, which allows creation or editing of drivers.

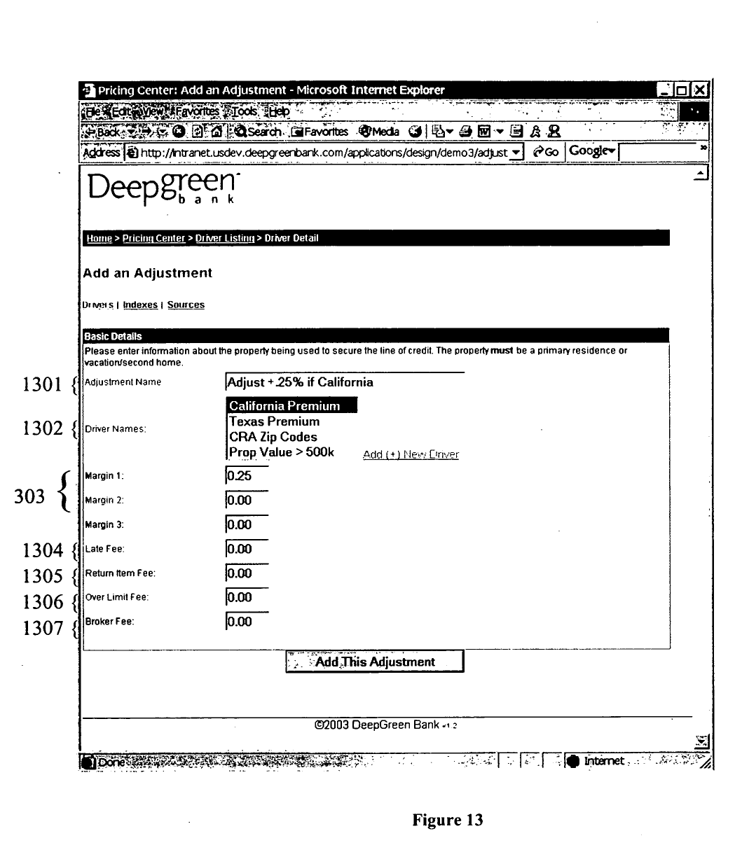

FIG. 13 is the Adjustment Form, which allows the creation of an adjustment to the rate by applying a margin. It is also the form where fees are setup or edited.

### DETAILED DESCRIPTION OF THE INVENTION

FIG. 1-3 assist in communicating the high level view of the Price Point Model and how it functions with an application. FIG. 4-13 depicts the necessary steps required to configure the model so it functions as designed.

FIG. 1 illustrates the Price Point Model. The Family 101 is basically a collection of programs 102 sharing similar product 104 attributes. In banking terms, the idea of a product and a family are extremely similar. Families are tied to a specific banking product 104 and index 105.

Within families lie programs 102, each of which represent a single qualification tier with its own specific rate. Qualification for a program is based on FICO, DTI, CLTV, Line Amount ranges, or any other loan attribute that the business determines to use as qualifiers. These “qualifiers” (FICO, etc.) are known as “standard drivers”, as they are built directly into and must be set for every program.

A program's rate may be increased or decreased further based on adjustments 106. An adjustment is simply that; a rate adjustment which increases or decreases a rate. Adjustments are tied to drivers 106 a), which define the qualifying criteria associated with an adjustment (such as geographic locations, property type, etc).

Each family (along with a family's programs) can be tied to one or more sources 103. Sources represent the origin of an application, and include a combination of the channel 103a), which is a general customer grouping for retail, wholesale; delivery (technology) 103b), which is technology used to provide an application such as XML or web; and party 103c) (company) involved with a transaction.

FIG. 2 represents a loan application submitted through a Source 201. At underwriting time, the Unifi system gathers underwriting information and generates a loan decision. Once a decision has been made, the process of determining an offer begins.

The offer process can be described as “determine families 202 eligible for this source, then determine which programs 203 this application qualifies for”. During the offer process, the Unifi looks up the source of the loan, and then queries for all programs whose families the source is eligible for. Once eligible programs have been determined, the system determines whether the application qualifies for each individual program based on the ranges set in standard drivers (FICO, CLTV, DTI, Line Amount, etc). In the diagram, the source qualified for families B and C. The customer qualifies for programs 5, 7, and 8, which will be displayed to the customer as an offer 204.

FIG. 3 illustrates the DeepGreen Financial rate matrix. This matrix represents three families, two for Heloc and one for Heloan. It also provides the program name, product number, Index (Prime2, Libor, etc), Min and Max FICO and CLTV, Margin adjustments, broker fees, and the rate tied to that specific program.

FIG. 4 is a prototype of the Pricing Center of Price Point. This is the main user interface required to configure the parameters required to set up products, create 403 or edit 404 families, create 406 or edit 405 programs, sources 401, channels, indexes 402, drivers, pricing features, adjustments, and offers. Each parameter requires one click for the detailed form for set up.

The pricing center is located in a secured section of the intranet, and is centered around a main screen displaying all active families and programs. From this screen, you can access all features of the pricing center.

To use the pricing center, you must perform the following tasks:
1. Make sure all available products have been created in the Underwriting system, and have product reference material available.
2. Make sure all indexes have been created and are active in the system of record, and have reference material available.
3. Create all sources prior to creating families and programs.
4. Create families and their associated programs one at a time.
5. Do not assign sources to a family until all programs have been added to a family.

The main pricing center screen is shown in FIG. 4, and lists all active families, programs, along with the products and rates associated with them.

A product is created outside of Price Point within the underwriting system. It is a named set of lending terms, conditions, and underwriting rules that define a single, named service offering. A product is generally defined by absolute underwriting rules concerning how a lending instrument acts, as well as the absolute bounds of eligibility (underwriting), such as maximum CLTV and minimum FICO.

With the pricing center, we have detached product pricing from product creation. Individual products can now have separate and distinct pricing criteria associated with them using the pricing center. For example, the same product 6000 (heloc) can have different pricing depending on the source of the application. To associate pricing to a product, see the remaining sections of this document.

FIG. 5 is the prototype of the form used to create 403 or modify 404 a family.

To create a family, do the following:
1. Go to the main Pricing Center screen
2. Click “Create a new Family”
3. Enter a name for the family
   This name should relate to the product name
   This name will be seen by consumers, partners, and brokers
   This name should be determined by marketing
   Example name: “DeepGreen Deluxe Home Equity”
4. Enter default values for line amounts 501, CLTV 502, FICO 503, etc
   These values will automatically populate for these fields when creating programs for this family. They are simply used to help speed the process of creating programs for this family.
Choose a product type 504
   Product should be the only product for all programs in this family
Choose an Index 505
   At this time, indexes are defaulted from the family screen, but are actually set by program. This is an incorrect implementation of the pricing model, and should be corrected in later iterations. At no time should a family have programs with dissimilar indexes.
   At this time, both variable and fixed rate products must have a corresponding index associated with them. Fixed rate products will not have an index associated to them in future iterations, and will instead have a base rate field that can be modified.
Choose all sources 506 that are eligible for this family and all of its programs
   ***SPECIAL NOTE*** Changes to families occur immediately. Do not associate sources to family unless you are ready for programs associated with this family to be offered to customers from that source.
8. Click “Add this Family”
   The family is added immediately
   You should begin adding programs to the family
      Updating a Family

To update and change characteristics of a program, do the following:
1. Go to the main pricing screen
2. Click on the name of the family you'd like to change 404
3. Change program defaults, if needed
4. Change sources 506, if needed
   By checking an unchecked source, that source becomes eligible for all programs in this family
   By unchecking a checked source, that source becomes ineligible
   Changes occur IMMEDIATELY upon clicking “Update this family”
   ***Special Note*** Active offers for programs within this family remain active even after a source is disassociated with a family.
5. Click “Update this Family”
   Changes occur immediately
      Deleting a Family

For audit and reporting reasons, families cannot be deleted. However, you may deactivate a family by unchecking all sources 506 associated with the family. Doing so ensures that no new loan applications will receive an offer for a program in that family. For instructions on how to disassociated a source with a family, please see the “Updating a Family” section.

***Please Note***

Customers that have already received an offer for a program that resides in a family that has been disassociated from a source or deactivated completely will continue to be eligible for that offer until the offer expires. There is no way to revoke offers sent to a customer without a manual change in the underwriting system.

FIG. 6 is a prototype of the form used to setup or edit programs. Associated with a family, a program is a set of standard qualifying criteria along with a rate. Also considered a pricing tier, programs resemble the line items rates found on traditional bank pricing sheets.

Some things about programs
In general, programs are meant to be mutually exclusive within a family (i.e., underwriting tiers should not overlap)
Indexes should be the same across all programs within a family
Product types should be the same across all programs within a family

To create a program, you must first have created a family to associate with the program. After you have created a family, do the following to create a program:
1. Go to the main pricing screen
2. Click “Add New Program” under the family for which you'd like to create a program
3. Enter basic details:
Program Name 601
   A simple name assigned to this pricing tier
   Currently is viewable by internal staff and brokers
   may be viewably by consumers at some point, so its best to name with that in mind
Product 602
   The numeric product type
   ***Special Note*** Product is incorrectly associated to programs in the current implementation of the pricing project. All programs within a family should be setup with the same product type in order to ensure long term system compatibility
Term 603
   The term of the product in number of months
   ***Special Note*** Term is incorrectly associated programs in the current implementations of the pricing project. All programs within a family should be setup with the same term in order to ensure long term system compatibility.
4. Enter Qualifiers. Qualifiers determine who is eligible for this program. In order to be eligible for this program. In order to be eligible for a program, an applicant must meet all qualifiers listed below.
Line Amount 604
   offer amount in dollars
   the minimum and maximum line amount returned from Unifi must fall in this range in order to qualify
CLTV 605
   expressed as loan-to-value percentage
   combined loan to value for applicant property must fall within this range.
FICO 606
   credit score number
   applicant credit score must fall within this range
   Valid credit scores fall between 336 and 843.
FICO to Use 607
   either minimum returned FICO score number, or maximum returned FICO number
   when receiving more than one score from credit sources, you must choose which score should be used for eligibility purposes
Enter Pricing
Pricing Index 608
   The index that this program's price is tied to
   Is selected from a pre-populated list of indexes
   ***Special Notes*** For fixed rate products (i.e., HELOANs), you should choose the index that matches the product selected for this program. Rates can then be altered with the margins shown below.
Margin 1 609
   Margin applied to draw period
   Shown as a positive or negative amount, in percentages
   For example, if the base index was 5.000%, clicking “+” and entering “1.000” would add this margin to the base index for a new rate of 6.000% during the draw period.
Margin 2 610
   Margin applied to repay period
Margin 3 611
   Margin applied to specified initial period (“teaser” period)
   ***Special Note*** This margin is not currently implemented, but may be in a future iteration.
6. Enter Fees and Payments
Late Charge Fee 612
   Fee charged to customer, in dollars, on late payments
Return Item 613
   Fee charged to customer, in dollars, for returned items (i.e., bounced payment check)
Over Limit Fee 614
   Fee charged to customer, in dollars, when customer has exceeded their line limit
Broker Compensation 615
   Fee paid to brokerage, in dollars, upon closing of loan

7. Click “Add this Program”

Updating a Program

Program updates are effective IMMEDIATELY upon clicking “Update this Program”. To update a program, do the following:
1. Go to the main pricing screen
2. Click on the name of the program you'd like to update
3. Change basic details
4. Change Qualifiers
5. Change Pricing
   ***Special Note*** Pricing changes occur immediately saving changes!
6. Change Fees and Payments
7. Click “Update this Program”
   Deleting a Program

Programs cannot be deleted in the current iteration of pricing. To remove programs, it is suggested that you remove all sources for the family the program is associated with, thus deactivating the family and all of its programs. Of course, this will remove all programs from being offered. In the event that only one program is slated for removal, it is suggested that a new family is created, and all programs that the bank wishes to keep are duplicated.

FIG. 7 is a prototype of the Source Listing. It provides all sources that have created as of that date.

A source is a combination of the primary business partner, channel, and delivery technology providing a customer application to DeepGreen Bank. Sources are often confused with channel (such as retain/B2C, wholesale/B2B, etc) or systems (“web site”, “xml”), so users should always remember that sources should represent a company and a channel and a delivery technology, not simply a computer system. Each application has a source, and each source has a series of costs (“deferred fees”) associated with it. By tracking sources, we are better able to determine total underwriting costs associated with each individual loan application, and can compensate partners accordingly.

A few things about sources:
Each application received is stamped with a two letter source
Channels are currently an attribute of a source. (***Special Note***: in the future, sources will have multiple channels, and channel will become a separate entity unrelated to source)
Deferred fees are directly associated with sources, and are setup using the source creation and update tool.

FIG. 8 is a prototype of the Source Form where you would create or edit a Source.

Creating a Source

To create a source, do the following:
1. Go to the main pricing screen
2. Under “Pricing Center Options”, click “Sources”
3. At the bottom of the screen, choose “Create New Source”
4. Enter Source information
Source Name 801
   The formal or business name
Short ID 802
   A two letter code for the source
   This ID is stamped on each new loan application at time of application
Channel 803
   A channel is used to describe the type of customer relationship DeepGreen has with the consumer applying for a loan
Internal/External 804
   Used to designate whether a source is owned/operated by DeepGreen Bank.
   Internal sources: “www” or web site, GreenSource, etc
   External sources: Nationwide, Lending Tree, etc.
Cobrand Subdomain 805
5. Enter Fees and Properties 806
   Loan Reassignment
   Deferred Fee
6. Enter Contact Information 807
7. Click “Add this Source”
   Updating a Source

To update a source, do the following:
1. Go to the main pricing screen
2. Under “Pricing Center Options”, click “Sources”
3. Click on the name of the source you'd like to update
4. Change Source information
5. Change Fees and Properties
6. Change Contact Information
7. Click “Update this Source”
***IMPORTANT*** Changing source information is not recommended for sources that already have loan applications in productions. Manual data changes must occur when altering some source information. See the IT department for more information prior to altering source name, short ID, channel, or cobrand subdomain.
   Deleting a Source

Sources cannot be deleted in the current iteration of Pricing. Please see the IT department for more information.

Channel

A channel is used to describe the type of customer relationship DeepGreen has with the consumer applying for a loan. There are several common channels, including business to consumer (“B2C”), business to business (“B2B”), and brokerage (“TPO”).

Index

FIG. 9 is the prototype of the Index Listing. An index is a base rate prior to adjustments that can be associated to a product.

FIG. 10 is the Prototype of the Index Detail Form. This Form will allow you to create or edit an index.

Creating an Index

Index creation requires manual changes within both the Underwriting system and the system of record in the current iteration of the Pricing tool.

Updating an Index

To update a source, do the following:

1. Go to the main pricing screen

2. Under “Pricing Center Options”, click “Indexes”

3. Click on the name of the index you'd like to update

4. Change index information:
Index Name
   cannot be changed
Index display name 1001
   The name of the index shown to consumers and system users
   Choose a name that relates to an index understood by consumers, such as “prime” or “prime rate”
Rate 1002
   The rate of the index that is applied to lines/loans prior to adjustments

5. Click “Update this Index”
***SPECIAL NOTE*** Index changes are effective at midnight on the day changes have been made.
   Deleting an Index

Indexes are tied to specific lines/loans over the lifetime of the line/loan, and cannot be deleted.

View History of Index Changes

For audit purposes, the index tool displays all rate changes made to an index over the lifetime of an index (since the release of the pricing tool). To view all rate changes for an index, simply go to the index screen and choose and index. Change history is shown at the bottom of the screen.

FIG. 11 is the prototype of the Driver Listing screen. A driver is a specific eligibility criterion, or rule, which determines whether a program or family is subject to a specific adjustment. Drivers are separate from, but tied directly to adjustments. Each driver must be tied to an adjustment.

Drivers come in two forms: standard drivers, and added drivers. Standard drivers are the main, industry-standard qualification criterion used to determine eligibility in every program. Our current set of standard drivers include the following:
FICO (max and min)
CLTV (max and min)
Line Amount (max and min)
DTI (coming soon)

These drivers are built directly into each program screen, and apply to all programs.

For maximum flexibility, users can also create additional drivers, known as “added drivers”. This functionality is not available in the current iteration of the pricing center. An example driver would be “collateral property located in the state of Texas”.

FIG. 12 illustrates the Driver Detail prototype. The Driver Name 1201 is created or edited and a short description 1202 is provided. A shortened or variable name 1203 may also be entered for reporting purposes. The “In List” or “Not in List” radio buttons 1204 allow you to display what is included in the Driver Listing screen. The business rules 1205 associated with the driver are created at the bottom of this form and include “Equal To”, “Different From”, or “Between ‘x’ and ‘y’”.

Pricing Feature

A pricing feature is the standard set of modifiable pricing, fee, and cost related characteristics of a product. In the current iteration of the pricing center, pricing features are set and modified within individual programs. Future iterations will allow features to be modified via drivers and adjustments. Pricing features can only be added and deleted via a manual process.

Our current set of pricing features include the following:
Index
Margin1
Margin2
Margin3
Broker fee
Late fee
Over limit fee
Returned item fee

FIG. 13 is the prototype of the Adjustment Form. An adjustment is the named combinations of a driver and a modification of one or more pricing features. For example, when an application qualifies for a driver, an adjustment increases the rate or fee associated with the driver.

Using our driver example previously (“collateral property located in the state of CA”), as could create an adjustment called “Adjust +0.25% if California” 1301. When we create the adjustment, we would the “California Premium” driver 1302, and then enter modifications to one or more pricing features. By enter “+0.25” to margin 1303, we will have effectively raised the rate for all programs in this family where the property was located in Texas.

More than adjustments:
Adjustments work directly with drivers, and are applied directly to families (not programs). Future iterations may have adjustments and drivers tied to either families or programs
In order for an application to receive an adjustment, it must meet a driver's eligibility requirement.
Adjustments move pricing features up or down, increasing or decreasing rates and/or fees
The late fee 1304 may be modified on the adjustment screen and tied to specific business drivers.
The returned Item fee 1305 may be modified on the adjustment screen and tied to specific business drivers.
The Over Limit fee 1306 may be modified on the adjustment screen and tied to specific business drivers.
The Broker fee 1307 may be modified on the adjustment screen and tied to specific business drivers.
   Offer
   An offer is the typing of a specific program to a specific application. Offers are made at loan decisioning time by the Unifi underwriting system, and contain one or more programs, each having an expiration date.

The new Channel Pricing will allow the business to offer multiple programs at different rates to customers. The programs will be determined by pre-defined underwriting criteria set by the Pricing Committee. The actual underwriting rules for the loan have not been changed. This means today's check against credit score, First Mortgages, Second Mortgages, and Other Mortgages will still be in effect.

Offers can be made each time Unifi decisions a loan, including the initial counter offer, as well as the final counter-offer (assuming a valuation was not initially available).

Underwriting and Determining Offers

The programs selected upon application are based off of loan parameters as well as system date and time. Each program that is created is stamped with the Time and Date it is active from. Any changes made to programs are considered updates. Updates to the program are also Time and Date stamped. A start time and start date will be added to the Updated program and an end time and end date will be added to the previous program. All applications that where applied for during the previous programs life cycle will not be eligible for the Updated Program.

Offers are determined by the Unifi underwriting system using a combination of the following:
Underwriting rules in the Unifi system
Product related underwriting rules
Family related eligibility, such as source
Program related eligibility, such as FICO and CLTV
Other driver related eligibility, such as the state a property is located

The Unifi system first looks to underwriting rules related to the product the customer has applied for, and tests the application for eligibility against each individual program in families that are associated with the source the loan came from.

Offer/Underwriting Example

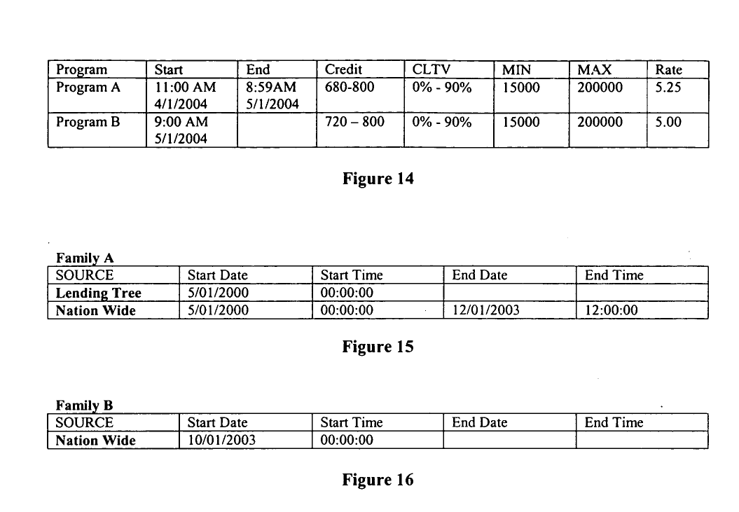

Scenario 1 (see FIG. 14)
1. Customer applies for loan on Apr. 30, 2004, at 12:30 PM.
   a. Credit Score of 730
   b. Valuation of $250,000
1. Customer is Conditionally approved for Program A
   a. Interest Rate of 5.25
   b. Loan Minimum of $15,000
   c. Loan Maximum of $200,000
3. Loan Operations orders BPO for loan
4. BPO is returned for loan on May 5, 2004 at 6:00 PM
5. Customer is still only eligible for Program A because their original application date is Apr. 30, 2004 at 12:30 PM.
6. Program B is not available because the program was created on May 1, 2004 at 9:00 AM.

Scenario 2
2. Customer applies for loan on May 1, 2004 at 12:30 PM.
3.
   a. Credit Score of 730
   b. Valuation of $250,000
4. Customer is Conditionally approved for Program B
   a. Interest Rate of 5.00
   b. Loan Minimum of $15,000
   c. Loan Maximum of $200,000
   d. The customer is not eligible for Program A because Program A expired at 8:59 AM on May 1^{st}.
5. Loan Operations orders BPO for loan
6. BPO is returned for loan on May 5, 2004 at 6:00 PM
7. Customer is still only eligible for Program B because their original application date is May 1, 2004 at 12:30 PM.

Program A is not available because the program was expired on May 1, 2004 at 8:59 AM.

Counter-Offers

A counter offer occurs when a final property valuation has been returned. When a counter-offer is returned, original offers may be rescinded, or “expired”.
1.
8. Removing Sources from Families
   a. Description of Process
i. Sources work in the same manner as Programs. Each Source is assigned a time stamp tracking when the source is assigned to a family as well as when it is removed from family. The application's time stamp will be used to determine what families the source is participating in.
ii. If a source is removed from a family, the relating source is time stamped as to when the source was dissociated to the family. This time stamp helps determine which current loans are still eligible for programs within the family for a given source.
iii. EXAMPLE ii
   (see FIGS. 15 & 16)
iv. Scenario I
   1. Customer applies for a DeepGreen Loan via the Nationwide Channel on Oct. 12, 2002.
   2. The customer is eligible for any loans offered within Family A but not Family B. This is only true for loans they are qualified for.
v. Scenario II
   1. Customer applies for a DeepGreen Loan via the Nationwise Channel on Nov. 12, 2003.
   2. The customer is eligible for any loans offered within Family A and Family B. This is only true for loans they are qualified for.
vi. Scenario III
   1. Customer applies for a DeepGreen Loan via the Nationwide Channel on Jan. 12, 2004.
   2. The customer is eligible for any loans offered within Family B but not Family A. This is only true for loans they are qualified for.

We claim:

1. A model for flexible rates that require the following steps to set up:
a) create qualification criteria
b) save this qualification criteria
c) tie criteria to a specific rate adjustment
d) tie this criteria to a program
e) tie this criteria to a family
f) use this criteria to determine eligibility of programs
g) Create a driver from any data source available.

2. A model that allows the use of families for specific sources

3. A model that allows specific programs to be set up within families that have similar products and indexes.

4. A model that allows the flexibility to add any tribute of a loan product as a driver for adjustments.

5. A model that allows for standard and additional drivers.
a) Standard drivers are built into the program(s).
b) Additional drivers may be added such as geographic location, etc.

6. A model that allows the adjustment to be assigned to an entire family.

7. A model that allows the adjustment to be assigned to a program.

8. A model that allows the trace ability of changes to the setup parameters.

9. A model that may have its parameters changed without changing the parameters of the loans already booked in the system of record.

10. A model that ensures the correct rates and rules are applied to the appropriate loans based on time and date stamps.
